(19) United States
(12) Patent Application Publication
(10) Pub. No.: US 2008/0149787 A1
(43) Pub. Date: Jun. 26, 2008

(54) Stand for hitch receiver rack system

(76) Inventor: Robert James Cole, San Mateo, CA (US)

Correspondence Address: ROBERT J. COLE, 504 COLGATE WAY, SAN MATEO, CA, 94402, US

(21) Appl. No.: 11/999,098

(22) Filed: Dec. 3, 2007

Related U.S. Application Data
(60) Provisional application No. 60/868,287, filed on Dec. 1, 2006.

(51) Int. Cl. B60R 9/06

(52) U.S. Cl. 248/126; 224/502; 211/195

(57) ABSTRACT

Aspects of the invention include a support for a rack, such as a sport utility rack that is configured for holding and/or transporting equipment, for instance, bicycles, skis, snowboards, and the like. In certain embodiments, the support is configured for engaging a portion of a sport utility rack, such as those known in the art that include a trailer hitch engagement portion capable of being joined to a trailer hitch receiving element of a vehicle in order to be transported thereby, so as to hold and/or maintain the rack while the rack is not engaged with the vehicle. In certain embodiments, the support is adapted for engaging a trailer hitch engagement portion of a sport utility rack so as to store the rack, while not being engaged with a vehicle, e.g., during transport, and for bearing the weight of the rack while the rack is partially or fully loaded with equipment, such as sports utility equipment (e.g., bicycles). Specifically, in certain embodiments, a support for a utility rack is provided, wherein the support may include one or more of a base member, a stabilizing leg component, and/or a utility rack engagement element. Methods of assembling and using the support for holding and/or bearing the weight of a utility rack, e.g., for storage, are also provided herein.

### BACKGROUND OF THE INVENTION

Rack systems for the vehicular transportation of utility equipment, such as sports utility equipment, including bicycles, skis, snowboards, and the like, are well known in the art. For instance, a variety of rack systems have been developed so as to be mounted to a vehicle via a trailer hitch receiver element. Such racks often include an engagement portion that is designed to be inserted into a trailer hitch receiver element, which receiver element is mounted on to the underside of a vehicle. For example, these rack systems include an attachment portion whereby various equipment, such as bicycles, skis, snow boards, or the like, may be associated with the rack, and a mounting portion, which portion of the rack includes a trailer hitch engagement portion that may be inserted into a trailer hitch receiver element so as to mount the rack to the vehicle and thereby allow for the various equipment associated with the rack to be transported.

However, such rack systems are typically bulky, rigid, heavy and difficult to move. Further, when not mounted to a trailer hitch receiver element of a vehicle, the rack, in and of itself, is unstable and therefore incapable of effectively and efficiently supporting the equipment typically associated therewith. Accordingly, when not mounted to a vehicle, the rack is virtually rendered useless and must be stored out of harms way. This results in several difficulties, not the least of which includes the problem of storing the rack when it is not mounted onto the vehicle, storing the equipment when not associated with the rack, and the added risk or damage that may result to the rack and/or equipment due to the improper storage thereof.

Specifically, given the bulky, irregular shape, and rigid nature of such racks, it is difficult to find an adequate storage location so as to safely store the rack. Often times such racks are left in a half-hazard manner on the floor of an owner's garage. However, when not associated with equipment, such as bicycles, skis, snow boards, and the like, the rack may be difficult to see for a driver attempting to enter and/or park in the garage.

Further, because the rack is not designed to be used while not mounted to a vehicle, this requires the owner of the rack system to purchase yet another storage rack designed to safely store the equipment that would in fact be capable of being associated with the rack and stored therein if the rack system were mounted to a vehicle. Accordingly, in an effort to save costs, many owners of such equipment, e.g., sports equipment, often simply find alternative methods of storing such equipment and in certain instances simply lean the equipment against the wall of the garage. However, bicycles, skis, snow boards, and the like, stored in this manner may slide, or otherwise fall away from the wall, and thereby damage parked vehicles and/or present a hard to see obstacle for either a person who may trip over them, causing personal injury, or a driver who may drive over them causing damage to the equipment and/or vehicle.

In an attempt to avoid such hazards, many owners of such racks leave them mounted to the vehicle, regardless if the rack system is in use or not. This in itself presents a number of other difficulties. For instance, many of these rack systems hamper access to the rear of the vehicle often times restricting the use of a tailgate of a truck, rear door of an SUV, or the trunk of a car, which is at least partially blocked by the rack system that is mounted to the rear of the vehicle.

Additionally, rack systems that are not in use, and yet left mounted to a vehicle, can create a safety hazard. Such rack systems extend from the rear of a vehicle, and when not loaded have a low profile, which low profile makes them hard to see by a driver of the vehicle. Accordingly, unloaded racks may increase a driver's chances of hitting an object, such as another vehicle, when the driver is backing up or into a parking space, especially in circumstances wherein the driver is unaware, or forgets that the rack system is still attached to the vehicle.

What is needed, therefore, is a stand that is configured to support a rack system, whether it is loaded to its capacity or not, in an upright position on a flat or uneven surface, such as a garage floor, thereby enabling the rack system to be used as designed, and not limited to use only when mounted to a tow hitch receiver element of a vehicle. The subject invention presented herein meets these and other needs in the art.

### SUMMARY OF THE INVENTION

Aspects of the invention include a support for a rack, such as a sport utility rack that is configured for holding and/or transporting equipment, for instance, bicycles, skis, snowboards, a wheel chair, and the like. In certain embodiments, the support is configured for engaging a portion of a sport utility rack, such as those known in the art that include a trailer hitch engagement portion capable of being joined to a trailer hitch receiving element of a vehicle in order to be transported thereby, so as to hold and/or maintain the rack while the rack is not engaged with or otherwise mounted on the vehicle. In certain embodiments, the support is adapted for engaging a trailer hitch engagement portion of a sport utility rack so as to store the rack, while not being engaged with a vehicle, e.g., during transport, and for bearing the weight of the rack while the rack is partially or fully loaded with equipment, such as sports utility equipment (e.g., bicycles).

Specifically, in certain embodiments, a support for a utility rack is provided, wherein the support includes one or more of: a base member, a stabilizing leg component, and/or a utility rack engagement element. Accordingly, in certain embodiments, the support includes a rack engagement element, which engagement element may be raised vertically, substantially normal to a horizontal plane of a surface upon which the overall stand rests. In certain embodiments, a base member is included, which base member functions to provide a structure for the securing of the various other elements of the support. In certain embodiments, a stabilizing leg component may be included, which stabilizing leg component may be associated (e.g., moveably) with the base member and is configured for stabilizing the overall support, for instance, while the support is engaged with a utility rack, which utility rack may or may not be partially or fully loaded with equipment, such as sports equipment. In certain embodiments, the utility rack engagement element may be associated either with the base and/or the stabilizing leg component and is adapted for engaging a portion, e.g., a trailer hitch engagement portion, of a utility rack so as to secure the rack to the support. Methods of assembling and using the support for holding and/or bearing the weight of a utility rack, e.g., for storage, are also provided herein.

### BRIEF DESCRIPTION OF THE DRAWINGS

According to common practice, the various features of the drawings may not be presented to-scale. Rather, the dimensions of the various features may be arbitrarily expanded or reduced for clarity. Included in the drawings are the following figures:

FIG. 1 provides a representative base member of the subject invention.

FIG. 2 provides a representative embodiment of a rack engagement element of the subject invention. FIG. 2A illustrates a rack engagement element. FIG. 2B illustrates another configuration of the rack engagement element. FIG. 2C provides a further configuration of a rack engagement element. FIG. 2D provides another configuration of a rack engagement element.

FIG. 3 provides a representative embodiment of a stabilizing leg component of the subject invention. FIG. 3A, provides a representative configuration of a leg component. FIG. 3B provides another configuration of the leg component which is a telescoping leg component. FIG. 3C provides a representative leg component that includes two portions of differing dimensions. FIG. 3D provides a leg component that includes two portions which are joinable by attachment to an adapter element. FIG. 3E provides a leg component that includes two leg portions that are movably associated with one another through an intervening joint element.

FIG. 4 provides a representative embodiment of a rack engagement element supporting member (e.g., a striker plate) of the subject invention. FIG. 4A provides a representative configuration of a striker plate. FIG. 4B, provides an embodiment of the striker plate wherein it includes a notch section.

FIG. 5 provides a representative embodiment of a support stand for a utility rack of the subject invention is provided.

FIG. 6 provides a representative embodiment of various components of a support stand for a utility rack of the subject invention.

FIG. 7 provides a representative embodiment of a base plate that is associated with a plurality of bracket members on a surface thereof in accordance with the subject invention. FIG. 7A one configuration of a base plate with a bracket and FIG. 7b provides a configuration of the bracket in addition to the rack engagement element received therein.

FIG. 8 provides a representative embodiment of a rack engagement element supporting member in association with a rack engagement element. FIG. 8A provides a rack engagement element supporting member with a notched portion. As shown in FIG. 8B a rack engagement element may be associated with the notched portion of the striker plate. FIG. 8C illustrates a base member that has been associated on a surface thereof with a rack engagement element supporting member and brackets.

FIG. 9 provides fully assembled stand support.

FIG. 10 provides a representative embodiment of a utility rack support stand. FIG. 10A provides a stand that includes a tubular base member in the shape of a raised pyramid. FIG. 10B provides a stand that includes a tubular base member in the shape of a T. FIG. 10C provides a stand that includes a tubular base member in the shape of a half-star.

FIG. 11 provides a representative embodiment of a rack engagement element and a rack engagement element supporting member of the subject invention.

FIG. 12 provides a top view perspective of a stand of the subject invention.

FIG. 13 provides a profile perspective of a stand of the subject invention.

FIG. 14 provides a profile perspective of a stand of the present invention supporting a rack system that is specifically designed to be inserted into a trailer hitch receiver.

FIG. 15 is a front perspective shown of the stand of the present invention with a rack system and bicycle 5.

### DEFINITIONS

Before the present invention is further described, it is to be understood that this invention is not limited to particular embodiments described, as such may of course vary. It is also to be understood that the terminology used herein is for the purpose of describing particular embodiments only, and is not intended to be limiting. Unless defined otherwise, all technical and scientific terms used herein have the same meaning as commonly understood by one skilled in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Throughout this application, various publications, patents and published patent applications are cited. The disclosures of these publications, patents and published patent applications referenced in this application are hereby incorporated by reference in their entirety into the present disclosure. Citation herein by the Applicant of a publication, patent, or published patent application is not an admission by the Applicant of said publication, patent, or published patent application as prior art.

It must be noted that as used herein and in the appended claims, the singular forms “a”, “and”, and “the” include plural referents unless the context clearly dictates otherwise. Thus, for example, reference to a “stabilizing leg component” includes a plurality of such members, and reference to “the base member” includes reference to one or more base members and equivalents thereof known to those skilled in the art, and so forth. It is further noted that the claims may be drafted to exclude any optional element. As such, this statement is intended to serve as antecedent basis for use of such exclusive terminology as “solely”, “only” and the like, in connection with the recitation of claim elements, or the use of a “negative” limitation.

In this specification and in the claims that follow, reference will be made to a number of terms, which shall be defined to have the following meanings:

“Optional” or “optionally present”—as in an “optional additive” or an “optionally present additive” means that the subsequently described component (e.g., additive) may or may not be present, so that the description includes instances where the component is present and instances where it is not.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### DETAILED DESCRIPTION

Aspects of the invention include a support for a rack, such as a sport utility rack that is configured for holding and/or transporting equipment, for instance, bicycles, skis, snowboards, and the like. In certain embodiments, the support is configured for engaging a portion of a sport utility rack, such as those known in the art that include a trailer hitch engagement portion capable of being joined to a trailer hitch receiving element of a vehicle in order to be transported thereby, so as to hold and/or maintain the rack while the rack is not engaged with the vehicle. In certain embodiments, the support is adapted for engaging a trailer hitch engagement portion of a sport utility rack so as to store the rack, while not being engaged with a vehicle, e.g., during transport, and for bearing the weight of the rack while the rack is partially or fully loaded with equipment, such as sports utility equipment (e.g., bicycles) or health related equipment (e.g., wheel chair, etc.).

Specifically, in certain embodiments, a support for a utility rack is provided, wherein the support includes one or more of: a base member, a stabilizing leg component, and/or a utility rack engagement element. Accordingly, in certain embodiments, the support includes a rack engagement element, which engagement element may be raised, e.g., vertically, substantially normal to a planed, e.g., horizontal plane, of a surface upon which the overall stand rests. In certain embodiments, a base member is included, which base member functions to provide a structure for the securing of the various other elements of the support. In certain embodiments, a stabilizing leg component may be included, which stabilizing leg component may be associated (e.g., moveably) with the base member and is configured for stabilizing the overall support, for instance, while the support is engaged with a utility rack, which utility rack may or may not be partially or fully loaded with equipment, such as sports equipment. In certain embodiments, the utility rack engagement element may be associated either with the base and/or the stabilizing leg component and is adapted for engaging a portion, e.g., a trailer hitch engagement portion, of a utility rack so as to secure the rack to the support. Methods of assembling and using the support for holding and/or bearing the weight of a utility rack, e.g., for storage, are also provided herein.

The subject support for a utility rack of the invention will be described first, followed by a description of its assembly and its use for the storage of a utility rack, which rack may or may not be partially or fully loaded with equipment, such as sports utility equipment.

Stand Support for Utility Rack

As summarized above, the subject invention provides for a collapsible support stand that is portable, easy to assemble and disassemble, and configured for engaging various rack systems currently available on the market in such a manner as to support the rack system, in a substantially upright position on the surface of a floor, so as to allow the rack system to be used for securing and storing equipment in a way that is similar to how the rack system would be used if mounted to a vehicle. Hence, the support stands of the present invention allow utility rack systems, such as those known and commonly used in the art for the transportation of equipment via the mounting of the rack system to a vehicle, to be used for the storage and/or easy movement of such equipment when the rack system is not mounted to a vehicle. In certain embodiments, the support stands described herein are capable of supporting a utility rack, such as a sport utility rack, in a manner sufficient to allow the rack to function as an equipment storage rack, regardless of whether the rack is fully loaded to its capacity with equipment or not.

Accordingly, in certain embodiments, the subject invention provides for a stand support for a rack system, such as a sport utility rack. In certain embodiments, the support may include one or more of a base member, a stabilizing leg component, and/or a utility rack engagement element. In certain embodiments, the support may additionally include a support utility rack engagement element bearing member.

### The Base Member

In certain embodiments, a support stand of the subject invention includes a base member. A suitable base member may be any component that is capable of interacting with a utility rack engagement element so as to provide a structure for securing the engagement element in a predetermined position and/or for securing and/or positioning the engagement element with respect to one or more other components of the support stand assembly. For instance, a suitable base member may be a structure that is configured for positioning a rack engagement element in a raised arrangement with respect to a plane upon which the support stand as a whole rests. Accordingly, in certain embodiments, the base member is configured for providing an attachment structure for the engagement element and/or the other stand support elements. In certain embodiments, the base member is configured so as to act as a foundation for the over all stand support as a whole, whether the supported rack itself is unloaded, partially loaded, or loaded to its full capacity.

A suitable base member may be of any suitable size, shape, and dimension so long as it is capable of providing a structure for the overall stand support as a whole. For instance, in certain embodiments, the base member may have a circular, semi-circular, triangular, square, rectangular, trapezoidal, diamond, pentagonal, hexagonal, or other such shape. In certain embodiments, the base member may have a flat configuration and may be positioned horizontally in relationship to the plane upon which the stand as a whole rests (e.g., the base member may rest horizontally on the ground). In certain embodiments, the base member may have an extended configuration and may be positioned vertically, that is normal to the plane upon which the stand as a whole rests (e.g., the base member may be extended vertically away from the ground). For instance, in certain embodiments, the base member may be positioned horizontally, and therefore, have a predominantly lateral or x-axis dimension, and in certain embodiments, the base member may be positioned vertically, and have a predominantly longitudinal or y-axis dimension.

In certain embodiments, the base member may have one or more surface dimensions. For instance, in certain embodiments, the base member may be tubular and may have the shape of a substantially three-dimensional triangle, pyramid, cube, star, or other such three-dimensional shape. Specifically, in one embodiment, the base member may have the general shape of a trapezoid, which trapezoid rests horizontally, e.g., laterally, with respect to the axis of the earth. For instance, the base member may have a thickness dimension, a depth dimension, a width dimension, and both first and second parallel length dimensions, wherein the parallel length dimensions are of different units and the base, as a whole rests flat upon the ground. In another embodiment, the base member may have a generally triangular shape, which triangle vertically, e.g., longitudinally, with respect to the axis of the earth. For instance, the base member may have a height dimension, a width dimension, and two-intersecting length dimensions, wherein the intersecting length dimensions may be the same or different units and the base, as a whole rests vertically with respect to the ground, e.g., the length dimensions may comprise portions that are raise with respect to the ground.

Accordingly, in certain embodiments, the base member may have one or more thickness dimensions, depth dimensions, width dimensions, and length dimensions. For instance, in various representative embodiments, dependent in part on the material from which it is made, a suitable base member may have a thickness that ranges from a few millimeters to several inches, such as from about less than 1, 1 or 2 mms, or about 10 or about 20 or about 50 mms to about 6 to about 12 inches or more, such as from about ¼ or about ½ inch to about 3 inches, from about 1 inch to about 2 inches, including about 1.5 inches. In certain embodiments a suitable base member may have a length that ranges from about 3 or about 5 inches to about 24 or about 36 inches or about 48 inches, such as from about 9 or about 10 inches to about 18 or about 30 inches, including about 12 inches. In certain embodiments, a suitable base member may have a width that ranges from about 1 or about 10 mms to about 1 or about 3 or about 5 or 6 inches to about 24 or about 36 inches, such as from about 8 or about 10 inches to about 12 or about 30 inches, including about 15 or about 20 inches. In certain embodiments, a suitable base member may have a combination of different length, width or thickness dimensions, for instance, when the base member is in the configuration of a trapezoid, circle, or semi-circle.

A base member of the subject invention may be fabricated from any suitable material in accordance with methods well known in the art. For instance, a suitable base member material, such as a metal or rigid plastic, may be used to fabricate a base member using a method such as casting, e.g., into a mould, machining, welding, pressing, fabricating, cutting, e.g., excision by a laser, or the like. The base member may be fabricated from a single piece of material or from a composite of materials. A suitable material may be any material capable of forming a base member and rigid enough to act as a foundation for all the other components of the support stand, as well as the overall stand itself. Such materials include, but are not hereby limited to, metals and alloys; such as iron, lead, steel, titanium, aluminum, and the like; and rigid plastics, such as PVC, polypropylene, polystyrene, ABS, PET, polycarbonate, combinations thereof and the like.

In certain embodiments, the base member is configured for being associated with one or more other components of the support stand assembly. For instance, a base member may be configured for being associated with one or more of a stabilizing leg component, a utility rack engagement element, a utility rack engagement element bearing member (e.g., a striker plate), a stabilizing leg receiving component, a second base member, a securing bracket, and the like. For example, in certain embodiments, the base member is configured for being associated, e.g., moveably associated, with a stabilizing leg, and may further be associated, in a moving or non-moving manner, with a leg receiving component.

Accordingly, in certain embodiments, the base member includes one or more leg receiving components. A leg receiving component may be any component that is capable of associating a stabilizing leg component with a base member. For instance, in certain embodiments, a leg receiving component may be a fastener, vice member, a screw, hinge, weld, glue, leg receiving receptacle, or the like. For example, in certain embodiments, a leg receiving component is a leg receiving receptacle that is adapted for both receiving a stabilizing leg and associating the stabilizing leg with the base member.

Hence, in certain embodiments, the base member is associated with a leg receiving receptacle that is configured for receiving a leg component. Accordingly, a suitable leg receiving receptacle will have a dimension for receiving and/or otherwise interacting with a stabilizing leg. Specifically, the leg receiving receptacle should have a length, height, and width that is sufficient for receiving and comfortably, e.g., snuggly, accommodating at least a portion of a leg (e.g., stabilizing) component. In certain embodiments, the leg receiving component (e.g., receptacle) includes a lumen that is adapted for receiving, fitting, and housing at least a portion of a stabilizing leg. In this manner, at least a portion of a stabilizing leg may be removably inserted into the lumen of the leg receiving receptacle and thereby be associated with the base member.

In certain embodiments, the leg receiving component or receptacle has a width, height, and length dimension. For instance, in certain embodiments, the leg receiving receptacle includes a width dimension that is adapted to accept the width of a leg component, and may range from about 5 or 10 mms or 100 mms to about 3 or about 5 inches, such as about ½ or ¾ inch to about 2 inches or slightly more, including about 1 or about 1.75 inches or slightly more. In certain embodiments, the leg receiving receptacle includes a height dimension that is configured for at least partially receiving the height of a leg component that ranges from about 5 or 10 mms or 100 mms to about 3 or about 5 inches, such as about ¾ inch to about 2 inches or slightly more, including about 1 or about 1.5 inches or slightly more. In certain embodiments, the leg receiving receptacle includes a length dimension that ranges from about 1 or about 2 inches to about 24 or about 36 or about 48 inches, such as from about 4 or 10 inches to about 20 or about 30 inches, including about 5 to about 8 inches. In certain embodiments, the leg receiving receptacle has substantially larger width and height dimensions, wherein one or more of the width and height dimensions may be from about 6 inches to about 36 inches, such as about 12 inches to 24 inches, including 15 to 20 inches.

The leg receiving component may be welded, machined, or otherwise affixed to the base member (e.g., by gluing, such as when the base member is plastic), for instance, via a non-moving or moving association member (e.g., a hinge or pivoting member) such that the leg receiving component, and/or a stabilizing leg component connected therewith, is both stably and/or movably associated with the base member. For example, in certain embodiments, the leg receiving component may be associated with the base member via the attachment of a fastener, e.g., a screw, through the leg receiving component and into the base member.

Accordingly, in certain embodiments, a leg receiving receptacle component includes one or more openings, for instance, one or more openings on a first, second, third, and/or fourth side that are configured for receiving a fastener, such as a screw. In this mariner, a stabilizing leg component may be at least partially inserted into the leg receiving receptacle and a fastening member may be inserted through one or more of the openings of the leg receiving receptacle so as to engage the leg and thereby secure the leg within the leg receiving receptacle. In certain embodiments, the base member comprises a plurality, such as two, three, four, five, six, or more leg receiving receptacles and is therefore capable of being associated with a plurality, such as two, three, four, five, six, or more stabilizing legs.

In certain embodiments, the base member and/or stabilizing leg and/or leg receiving receptacle/component(s) are configured for being removably associated with an additional, e.g., top, base member. For instance, a second base member, such as an additional base member as that described herein above, may be added on top of a first base member and/or one or more leg components and/or one or more of a leg receiving receptacle member, in a sandwich like configuration, wherein the leg component and/or leg receiving receptacle component are sandwiched between a first and second, e.g., a top and bottom base member. In certain embodiments, this additional base member is included so as to give the over all support additional structural integrity and to disperse the load of the rack system across the length of at least one of the base members.

Accordingly, the base or second base member may include one or more openings, such as an opening configured for receiving a fastener, such as a rivet, screw, of the like, which fastener may be adapted to be inserted through the base member and thereby engage another component of the apparatus, such as an additional base member, leg, or leg receiving receptacle, or opening thereof, so as to secure the base member to said other component.

In certain embodiments, a base member, e.g., a first or second base member, is configured for being directly or indirectly associated with a rack engagement element. For instance, in certain embodiments, the base member is configured for being directly associated with a rack engagement element, for example, by direct attachment of the engagement element to the base via welding, gluing, screwing, or the like. In certain embodiments, the base member is configured for being indirectly associated with a rack engagement element, for instance, via the presence of one or more of an intervening striker plate, raised portion (e.g., bracket), or the like. For example, in certain embodiments, a first and/or second base member may be configured for being associated with a utility rack engagement element bearing member, or striker plate. The striker plate may be associated with the base member via welding, removable attachment, e.g., via screws, gluing, or by any other form of attachment well known in the art. As is described in greater detail herein below, the striker plate may then serve to indirectly associate the engagement element with the base member.

In certain embodiments, the base member is configured for being associated, e.g., moveably associated, with a raised portion or bracket, and may further be associated, in a moving or non-moving manner, with a utility rack engagement element. Accordingly, in certain embodiments, the base member is configured for being indirectly associated with a rack engagement element via the presence of an intervening raised or bracket portion. For instance, in certain embodiments, the base member includes a raised portion, such as a bracket, that projects from a top surface of the base member, which raised portion is configured for engaging both the base member and a utility rack engagement element. For example, where the base member is a triangular member, the raised portion may be one or more brackets that are mounted to the base member and extend or otherwise project longitudinally along the plane center axis above the base member. The raised portions may then attach to the rack engagement element, which element may be a rectangular shaped tow-hitch engagement portion receiver.

### The Stabilizing Leg Component

In certain embodiments, a support stand of the subject invention includes a stabilizing leg component. A suitable stabilizing leg component may be any member that is capable of interacting with a base member and/or leg receiving receptacle member and/or utility rack engagement element and is capable of acting as a stabilizer for the support of a utility rack. In certain embodiments, the stabilizing leg component is such that it is capable of interacting with the base member and/or leg receiving receptacle member and/or the rack utility engagement element to provide stabilization for the other stand support elements and the over all stand support whether the supported rack itself is unloaded, partially loaded, or loaded to its full capacity (e.g., with equipment).

A suitable stabilizing leg component may be of any suitable size, shape, and dimensions so long as it is capable of providing stabilization for the overall stand support. For instance, in certain embodiments, the stabilizing leg component may have a circular, triangular, square, rectangular, trapezoidal, diamond, pentagonal, hexagonal, flat, or other such shape. In certain embodiments, the stabilizing leg component is substantially flat, e.g., the leg component has a small thickness dimension relative to its length dimension. In other embodiments, the stabilizing leg component is tubular. For instance, in certain embodiments, the stabilizing leg component has the shape of a tubular circle, triangle, rectangle, or other such three-dimensional shape. In certain embodiments, the stabilizing leg component includes a portion that is tubular and a portion that is substantially flat or flattened. Specifically, in one embodiment, the stabilizing leg component may have a first portion that is tubular, e.g., a portion that is configured for being associated with a base member and/or leg receiving receptacle and/or rack engagement element, and a second portion that is substantially flattened. For instance, the stabilizing leg component may have a first and second portion that substantially differs in a thickness dimension, a depth dimension, a width dimension, and/or length dimensions. In this manner, when the rack is positioned on a surface, an object, such as the wheels of a car, may pass over the flattened surface of the leg component without causing substantial damage, if any, to the object.

In certain embodiments, the stabilizing leg component may have one or more thickness dimensions, width dimensions, and length dimensions. For instance, in certain embodiments, the stabilizing leg component includes a width dimension that is adapted to be accepted within the width of a leg receiving component, and may range from about 4 or 9 mms or 100 mms to about slightly less than about 3 or about 5 inches, such as about slightly less than ½ or ¾ inch to about 2 inches or slightly less, including about slightly less than about 1 or about 1.75 inches or slightly less. In certain embodiments, the leg receiving receptacle includes a height dimension that is configured for at least partially being received within the height of a leg receiving component that ranges from about slightly less than about 4 or 9 mms or 100 mms to about slightly less than about 3 or about 5 inches, such as slightly less than about ¾ inch to about 2 inches or slightly less, including about 1 or about 1.5 inches or slightly less. In certain embodiments, the leg component includes a length dimension that ranges from about 12 or about 24 inches to about 36 or about 48 or about 90 inches, such as from about 30 or 40 inches to about 60 or about 72 inches, including about 15 to about 20 inches. In certain embodiments, the leg receiving receptacle has substantially larger width and height dimensions, wherein one or more of the width and height dimensions may be from about slightly less than about 6 inches to about slightly less than 36 inches, such as about 12 inches to 24 inches, including 15 to 20 inches.

In certain embodiments, the stabilizing leg component may include one or more different thickness, width, and length dimensions. For instance, in certain embodiments, the stabilizing leg component may include a plurality of leg segments, wherein the leg segments are dimensioned to fit one within the other, for example, in the configuration of a telescope. Accordingly, in certain embodiments, the leg component includes two, three, four, five, six, seven, or more leg component segments, that are configured in a manner such that each segment is capable of receiving the following segment within the bounds of its dimensions, for instance, in the manner that the segments of a telescope fit one within the other.

In certain embodiments, the stabilizing leg component is made up of different segments, such that one or more of such segments have different height and/or length dimensions, such that the leg may be collapsible, for instance, like a telescope, wherein the leg being comprised of different adjoined segments is capable of being collapsed one segment within the other segment, so as to decrease its length. In certain embodiments, the stabilizing leg component includes a hinge joint so that one or more segments of the leg component may be pivoted and/or displaced in one or more directions and/or planes relative to one or more of the other segments of the leg components.

For instance, in certain embodiments, the stabilizing leg component includes a hinge portion, which includes a hinge member that allows at least a portion of the leg component to rotate and/or pivot with relation to one or more other portions of the leg. In certain embodiments, one or more or all of the joining segments of a plurality of leg components includes a hinge joint such that the leg may be adaptable to be positioned in a wide number of different configurations.

In certain embodiments, the stand support includes a single stabilizing leg component, which leg component may be associated with one or more of a base member and/or a leg receiving component and/or a utility rack engagement element. In certain embodiments, the support includes a plurality, such as two, three, four, five, six, or seven leg components that may be associated with one or more of a base member, leg receiving receptacle components and/or a utility rack engagement element.

In certain embodiments, the one or more leg components are directly associated with a base member and/or leg receiving component and/or strike-plate, and/or rack engagement element. For instance, in certain embodiments, a leg member may be directly welded, glued, or otherwise permanently attached to one or two base members and/or a leg receiving component and/or strike-plate, and/or rack engagement element, in a manner well know in the art. In certain embodiments, a leg component may be moveably associated with a base member and/or leg receiving component and/or strike-plate, and/or rack engagement element, for instance, by a moveable or pivoting attachment element, such as by a screw, pin, peg, or the like, configured for passing through one or more other components of the stand assembly, such as an opening in a leg receiving portion and/or passing through an opening in a leg component and into an opening in the base. In this manner, the leg and/or leg receiving component may pivot about the screw or pin along a surface of the base member in relation to an axis through the attachment element.

Accordingly, in certain embodiments, one or more of the base member, leg receiving receptacle component, and/or leg component, and/or strike-plate, and/or rack engagement element, may each contain one or more openings there through for receiving a screw, locking pin, peg, or the like. For instance, the base member may be configured as a semi-circle, triangle, square, trapezoid or the like, wherein the base member includes a plurality of openings for receiving a plurality of fasteners. Suitable legs and or leg receiving components, also including openings, may then be attached to the base member via appropriately sized fasteners. In this manner, the legs and/or leg components may be moveably associated to the base member in a variety of different configurations. Further, once one or more of the referenced components are fastened one to other, e.g., in movable relationship, one or more locking fasteners may be attached there through to lock the various components in place. Further, the base member may include one or more grooves in which the leg and/or leg receiving component is associated therewith such that the associated component may move in a predetermined manner with respect to the base member.

A stabilizing leg component of the subject invention may be fabricated from any suitable materials in accordance with methods well known in the art. For instance, a suitable stabilizing leg component material, such as a metal or rigid plastic, may be used to fabricate a leg component using a method such as casting, e.g., into a mould, machining, fabricating, cutting, e.g., excision by a laser, or the like. The leg component may be fabricated from a single piece of material or from a composite of materials. A suitable material may be any material capable of forming a stabilizing leg component and rigid enough to act as a stabilization member for all the other components of the support stand as well as the overall stand itself. Such materials include, but are not hereby limited to, metals and alloys; such as iron, lead, steel, titanium, aluminum, and the like; and rigid plastics, such as PVC, polypropylene, polystyrene, ABS, PET, polycarbonate, combinations thereof and the like.

### The Rack Engagement Element

In certain embodiments, a support stand of the subject invention includes a rack engagement element. A suitable rack engagement element, may be any element that is capable of directly or indirectly associating with a base member and/or a stabilizing leg component and/or a utility rack engagement element supporting member (e.g., a strike plate), and is configured for interacting with a trailer-hitch engagement portion of a utility rack, such as a sport utility rack. In certain embodiments, the rack engagement element is such that it is capable of interacting with a trailer-hitch engagement portion of a utility rack so as to support hold and/or maintain the rack while the rack is not engaged with the vehicle.

In certain embodiments, the rack engagement element is adapted for engaging a trailer hitch engagement portion of a sport utility rack so as to store the rack, while not being engaged with a vehicle, and for bearing the weight of the rack while the rack is partially or fully loaded with equipment, such as sports utility equipment (e.g., bicycles). In certain embodiments, the rack engagement element is capable of engaging trailer hitch engagement portion of a utility rack and, along with the other members of the assembly, supporting the rack in an upright position so as to ensure that the equipment retained or otherwise associated is maintained in an upright position and/or has minimal, if any, contact with the surface upon which the support is positioned.

A suitable rack engagement element may be of any suitable size, shape, and dimension so long as it is capable of engaging a trailer hitch engagement portion of a utility rack. For instance, in certain embodiments, the rack engagement element is tubular and may have a circular, semi-circular, triangular, square, rectangular, trapezoidal, diamond, pentagonal, hexagonal, or other such three-dimensional shape. In certain embodiments, the rack engagement element has an extended rectangular configuration and includes a lumen the inside of which is adapted for receiving and thereby engaging a trailer hitch engagement portion of a sport utility rack.

Accordingly, in certain embodiments, the rack engagement element includes at least one, two, three, four or more walls. For instance, in certain embodiments, the rack engagement element comprises an extended lumen that is bounded by four walls. Thus, the rack engagement element includes a proximal and distal portion, the proximal portion including an orifice through which a trailer hitch engagement portion may at least be partially inserted. The distal portion may also be open, e.g., so as to allow an extended portion of the trailer hitch engagement portion may pass through, or may include a fifth wall so to prevent the passage of the trailer hitch engagement portion from passing trough. Further, in certain embodiments, where a fifth wall is included, e.g., at the distal end of the engagement element, the wall may include a cavity configured receiving an end of the hitch engagement portion so as to be received therein in male to female relation and thereby further support the utility rack.

In certain embodiments, the rack engagement element includes at least two or three walls, which walls may be orientated to bound a cavity or otherwise open space. For instance, the rack engagement element may include two or three walls that are non-movably or moveably associated with a base member, support leg component, support leg receiving component or a strike plate. Specifically, in certain embodiments, the two or more walls of the rack engagement element may be directly, and immovably, associated with a base member and/or leg receiving component and/or leg component, and/or strike-plate. For instance, in certain embodiments, a wall of the rack engagement element may be directly welded, glued, or otherwise permanently attached to a base member and/or a leg receiving component and/or a leg component and/or strike-plate, in a manner well know in the art.

In certain embodiments, a wall of the rack engagement element may be moveably associated with another member of the stand assembly, e.g., a base member and/or leg receiving component, and/or leg component, for instance, where the other member of the stand includes a groove and/or rails within which one or more portions of the wall of the rack engagement element may be moved. In such an instance, the wall may include one or more moveable elements, such as a rotatable member, wheel, slide portion, and the like. Thus, the other member of the stand with which the wall is to be associated may include one, two, three, four or more elements; e.g., groove or rail elements, which are configured for allowing one or more walls of the rack engagement element to move in a predetermined direction. A suitable locking mechanism may also be included, such as one or a plurality of an indentation or pin or the like, so as to lock the wall in a selected position. In this manner, the one or more walls of the rack engagement element may be contracted or expanded so as to allow size, shape, and/or configuration of the rack engagement element to change so as to receive and/or engage different sized portions of a trailer hitch engagement portion.

Further, one or more walls or other associated portions of a rack engagement element may include one or more openings for receiving a hitch fastening element, such as a pin, rod, screw or the like, which fastening element is configured for contacting and/or passing through an aperture of a trailer hitch engagement portion and thereby functioning in conjunction with the other elements of the assembly to secure the trailer hitch engagement portion and/or associated rack in place within the rack engagement element. The hitch fastening element may also include an aperture for receiving a pin, rod, screw of the like, e.g., a cotter pin, so as to further secure the hitch fastening element in place.

In certain embodiments, a wall of the rack engagement element may have one or more thickness dimensions, height dimensions, width dimensions, and length dimensions. For instance, in various representative embodiments, dependent in part on the material from which it is made, a suitable rack engagement element may have a thickness that ranges from less than 1, 1, 2 or 3 millimeters to several inches, such as from about 4 or 5 mms, or about 10 or about 20 or about 50 mms to about 3 to about 6 inches or more, such as from about 8 mms or about 12 mms to about 2 inches, from about 30 mms to about ⅛ inch to about ½ inch, including about 25 mms. In certain embodiments a suitable rack engagement element may have a height that ranges from about ½ or about 1 inch to about 5 or about 6 inches, such as from about 1.5 or about 2 inches to about 3 or about 4 inches, including about 2.5 inches. In certain embodiments, a suitable rack engagement element may have a width that ranges from that ranges from about ½ or about 1 inch to about 5 or about 6 inches, such as from about 1.5 or about 2 inches to about 3 or about 4 inches, including about 2.5 inches. In certain embodiments, a suitable rack engagement element may have a length that ranges from about ½ or about 1 inch to about 8 or about 12 inches, such as from about 2 or about 10 inches to about 3 or about 6 inches, including about 2.5 to about 4 or about 5 inches.

A rack engagement element of the subject invention may be fabricated from any suitable material in accordance with methods well known in the art. For instance, a suitable rack engagement element material, such as a metal or rigid plastic, may be used to fabricate a rack engagement element using a method such as casting, e.g., into a mould, machining, welding, pressing, folding, fabricating, cutting, e.g., excision by a laser, or the like. The rack engagement element member may be fabricated from a single piece of material or from a composite of materials. A suitable material may be any material capable of forming a rack engagement element and rigid enough to act as a receiver for a trailer hitch engagement portion of a utility rack. Such materials include, but are not hereby limited to, metals and alloys; such as iron, lead, steel, titanium, aluminum, and the like; and rigid plastics, such as PVC, polypropylene, polystyrene, ABS, PET, polycarbonate, combinations thereof and the like.

As set forth above, in certain embodiments, the rack engagement element is configured for being associated with one or more other components of the support stand assembly indirectly. For instance, a rack engagement element may be configured for being associated with one or more of a base member, a stabilizing leg component, a leg receiving component, a utility rack engagement element bearing member (e.g., a striker plate), via a securing bracket, e.g., a raised portion, and the like. For example, in certain embodiments, the rack engagement element, is configured for being associated, e.g., moveably associated, with another component of the stand assembly, e.g., a base member, a stabilizing leg component, a leg receiving component, a utility rack engagement element bearing member, through a raised bracket member.

Accordingly, a bracket member, e.g., a raised portion, may be included so as to modify the association of the rack engagement element to another component of the stand assembly. For instance, a bracket member may be interposed between the rack engagement element and a base member, leg component, strike plate, or the like, so as to form an association between the two elements. In certain embodiments, the bracket member forms a raised portion, which portion may be configured to at least partially to receive one or more of at least a portion of the rack engagement element and/or at least a portion of another component of the assembly.

In certain embodiments, the bracket member includes at least two walls together which are configured for being associated with a component of the assembly and are further configured for receiving a rack engagement element. In such a configuration, the walls of bracket member may be extended and may include one or more openings through which a rack fastening member, such as a screw, pin, or the like, may be inserted so as to fasten the rack engagement element to the walls of the bracket member. Accordingly, the rack engagement element may include a plurality of openings configured for receiving a portion of a rack fastening member and being secured into the walls of a bracket thereby. In this manner, the vertical height of the rack engagement element may be modified, upwards or downwards in relation to the other associated component of the assembly, so as to control the vertical relationship of the rack with the engagement element and/or surface upon which the stand itself resides. In another embodiment, the rack engagement element is immovably associated with the brackets by being welded, glued, or other wise permanently attached thereto. In certain embodiments, the walls of the bracket member may be moveably associated with the component of the stand assembly, e.g., a base member and/or leg receiving component, and/or leg component, for instance, where the other member of the stand includes a groove and/or rails within which one or more portions of the wall of the bracket member may be moved. In such an instance, the wall may include one or more moveable elements, such as a rotatable member, wheel, slide portion, and the like. In this manner, the bracket member may be adjustable to accommodate different sizes of rack engagement elements.

In certain embodiments, the walls of the bracket member or raised portion may have one or more thickness dimensions, height dimensions, width dimensions, and length dimensions. For instance, in various representative embodiments, dependent in part on the material from which it is made, a suitable wall may have a thickness that ranges from less than 1, 1, 2 or 3 millimeters to several inches, such as from about 4 or 5 mms, or about 10 or about 20 or about 50 mms to about 3 to about 6 inches or more, such as from about 8 mms or about 12 mms to about 2 inches, from about 30 mms to about ⅛ inch to about ½ inch, including about 25 mms. In certain embodiments a suitable wall may have a height that ranges from about ½ or about 1 inch to about 15 or about 20 inches, such as from about 2 or about 3 inches to about 10 or about 12 inches, including about 4 to about 5 or 6 inches. In certain embodiments, a suitable rack engagement element may have a width that ranges from that ranges from about 1 mm or about 2 mm to about 2 or about 5 inches, such as from about 10 or about 25 mm to about ⅛ or about 1 inch, including about ½ inches. In certain embodiments, the distance between the walls of the brackets may be adjusted to include a length between the brackets that ranges from about ½ or about 1 inch to about 8 or about 12 inches or more, such as from about 2 or about 10 inches to about 3 or about 6 inches, including about 2.5 to about 4 or about 5 inches.

A bracket member or raised portion of the subject invention may be fabricated from any suitable material in accordance with methods well known in the art. For instance, a suitable bracket member material, such as a metal or rigid plastic, may be used to fabricate a bracket member using a method such as casting, e.g., into a mould, machining, welding, pressing, folding, fabricating, cutting, e.g., excision by a laser, or the like. The bracket member may be fabricated from a single piece of material or from a composite of materials. A suitable material may be any material capable of forming a bracket member and rigid enough to act as a receiver for a rack engagement element of the stand assembly. Such materials include, but are not hereby limited to, metals and alloys; such as iron, lead, steel, titanium, aluminum, and the like; and rigid plastics, such as PVC, polypropylene, polystyrene, ABS, PET, polycarbonate, combinations thereof and the like.

### The Utility Rack Engagement Element Supporting Member

In certain embodiments, a support stand of the subject invention includes a utility rack engagement element supporting member (e.g., a strike plate). A suitable rack engagement element supporting member may be any component that is capable of interacting with a utility rack engagement element so as to provide a foundation for securing the engagement element in a predetermined position and/or for securing and/or positioning the engagement element with respect to one or more other components of the support stand assembly. In certain embodiments, the rack engagement element supporting member is configured so as to act as a base or strike plate for the engagement element.

A suitable rack engagement element supporting member may be of any suitable size, shape, and dimension so long as it is capable of providing a foundation for the rack engagement element. For instance, in certain embodiments, the rack engagement element supporting member may have a circular, semi-circular, triangular, square, rectangular, trapezoidal, diamond, pentagonal, hexagonal, or other such shape. In certain embodiments, the rack engagement element supporting member may have a substantially flat configuration and may be interposed between the rack engagement element and another element of the stand assembly, such as a base member, leg component, leg receiving component, and the like.

In certain embodiments, the rack engagement element supporting member may have one or more surface dimensions. For instance, in certain embodiments, the base member may be tubular and may have the shape of a substantially three-dimensional square, rectangle, cube, or other such three-dimensional shape. Specifically, in one embodiment, the rack engagement element supporting member may have the general shape of an extended three-dimensional rectangle. In certain embodiments, the rack engagement element supporting member includes a distal and a proximal end and includes a notched portion on or near the proximal end. In certain embodiments, the notched portion is dimensioned to accept the rack engagement element such that the engagement element fits within the bounds of the notched portion and a surface of the bottom wall of the engagement element is flush with a top wall surface of the un-notched portion of the rack engagement element supporting member.

Accordingly, in certain embodiments, the rack engagement element supporting member may have one or more thickness dimensions, depth dimensions, width dimensions, and length dimensions. For instance, in various representative embodiments, dependent in part on the material from which it is made, a suitable rack engagement element supporting member may have a thickness that ranges from a few millimeters to several inches, such as from about less than 1, 1 or 2 mms, or about 10 or about 20 or about 50 mms to about 6 to about 12 inches or more, such as from about ¼ or about ½ inch to about 3 inches, from about 1 inch to about 2 inches, including about 1.5 inches. In certain embodiments a suitable rack engagement element supporting member may have a length that ranges from about 3 or about 4 or about 5 inches to about 24 or about 36 inches or about 48 inches, such as from about 9 or about 10 inches to about 18 or about 30 inches, including about 12 inches. In certain embodiments, a suitable rack engagement element supporting member may have a width that ranges from about 1 or about 3 or about 4 or 5 inches to about 8 or about 10, including about 6 or about 7 inches. In certain embodiments, a suitable rack engagement element supporting member may have a combination of different length, width or thickness dimensions, for instance, when the rack engagement element supporting member includes a notched portion that has dimensions that are equivalent to a bottom wall of a rack engagement element.

A rack engagement element supporting member of the subject invention may be fabricated from any suitable material in accordance with methods well known in the art. For instance, a suitable rack engagement element supporting member material, such as a metal or rigid plastic, may be used to fabricate a rack engagement element supporting member using a method such as casting, e.g., into a mould, machining, welding, pressing, fabricating, cutting, e.g., excision by a laser, or the like. The rack engagement element supporting member may be fabricated from a single piece of material or from a composite of materials. A suitable material may be any material capable of forming a rack engagement element supporting member and rigid enough to act as a foundation for an engagement element. Such materials include, but are not hereby limited to, metals and alloys; such as iron, lead, steel, titanium, aluminum, and the like; and rigid plastics, such as PVC, polypropylene, polystyrene, ABS, PET, polycarbonate, combinations thereof and the like.

### Other Useful Elements, Assembly, and Methods of Use

In certain embodiments, one or more components of the stand assembly, such as a stabilizing leg component and/or base member and/or other component of the stand assembly may include one or more of a support pad or wheel element, such as a caster or locking wheel. For instance, in certain embodiments, a moveable pad element or wheel element may be associated with one or more of the components of the assembly such that the pad or wheel height can be vertically adjusted. In this manner, where one or more height adjustable pads or wheels are included, the height dimensions of the stand assembly may be adjustable so as to compensate for any deformities of a surface upon which the stand assembly rests. Further, where locking wheels are included, the stand assembly, whether fully or partially loaded or not loaded at all, may be moved as desired and when appropriately positioned, the wheels may be locked so as to prevent any further movement. Additionally, where pad members are included, the pad components may be configured for bearing associated with one or more of a base component and/or a stabilizing leg member, or other component and may be height adjustable. The pad members may be made out of any suitable material such as metal, plastic, rubber, or the like and may be associated, for instance, with the corners of the base member or along the bottom of the leg members.

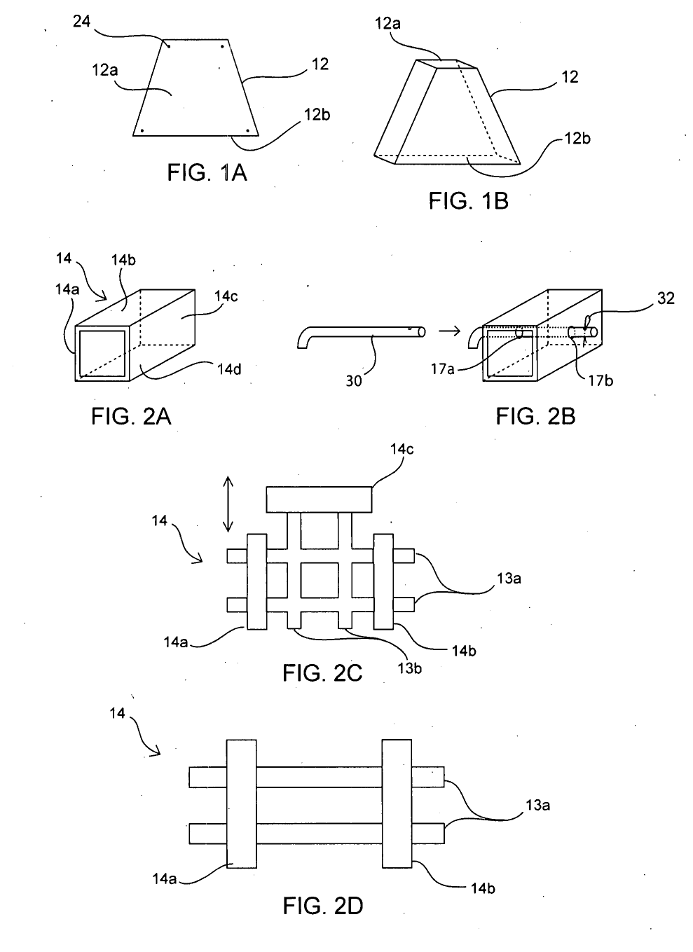

Various individual components of the utility rack stand support of the invention and their relationship to one another will now be described with reference to the figures appended hereto. With reference to FIG. 1, a representative base member (12) of the subject invention is set forth. In the embodiment of FIG. 1A, the base component (12) includes a top surface 12a and a bottom surface 12b and openings (24). The base (12) is shaped as a trapezoid and configured for lying flat (e.g. horizontally) upon a surface on which the stand as a whole is to rest. In the embodiment of FIG. 1B, the base component (12) includes a top surface (12a) and a bottom surface (12b). The base (12) is shaped as a three-dimensional trapezoid, but may also be more generally triangular, wherein the top surface (12a) may be configured for being associated with a rack engagement element (see FIG. 2) either directly, e.g., via welding, etc., or indirectly, via a raised portion, such as a bracket (not shown); and the bottom surface is configured for contacting a surface on which the stand as a whole is to rest. As shown the base (12) extends vertically from the bottom surface (12b) toward the top surface (12a).

With reference to FIG. 2, a representative embodiment of a rack engagement element of the subject invention is provided. In FIG. 2A, the rack engagement element (14) includes four walls (14a, 14, b, 14c, and 14d) which bound a lumen (15) into which a trailer-hitch engagement portion (not shown) may be inserted. As noted above, the rack engagement element (14) may have any suitable dimensions, such as dimensions that are standard in the industry, for instance, the length may be about 4 inches and the inner dimensions of the lumen (15) may be about 2 inches×2 inches, so as to receive an industry standard trailer-hitch engagement portion. FIG. 2B illustrates a rack engagement element (14) with openings (17) for receiving a locking element (30), such as a locking pin that is configured for being inserted through one or more walls (e.g., 14a, 14b) of the engagement element (14) and through an opening in the trailer-hitch engagement portion, thereby locking the trailer-hitch engagement portion in relationship with the engagement element (14). As shown, the locking pin (30) itself includes an opening (31) for receiving a locking pin (32), such as a cotter pin, so as to lock the locking pin (30) in relationship with the engagement element (14) and/or the trailer-hitch engagement portion. FIG. 2C provides a rack engagement element (14) that includes 3 walls (14a, 14b, and 14c). As illustrated the walls of the engagement element (14) are configured for being movably coupled to grooves (13a and 13b) because of which association the walls are capable of moving so as to change the dimensions of a cavity formed by the walls (14a, 14b, and 24c), and thereby allow the engagement element (14) to be adapted to various diverse dimensions of a trailer-hitch engagement portion. FIG. 2D provides a rack engagement element (14) that includes walls (14a and 14b), which walls are moveably associated with grooves (13a).

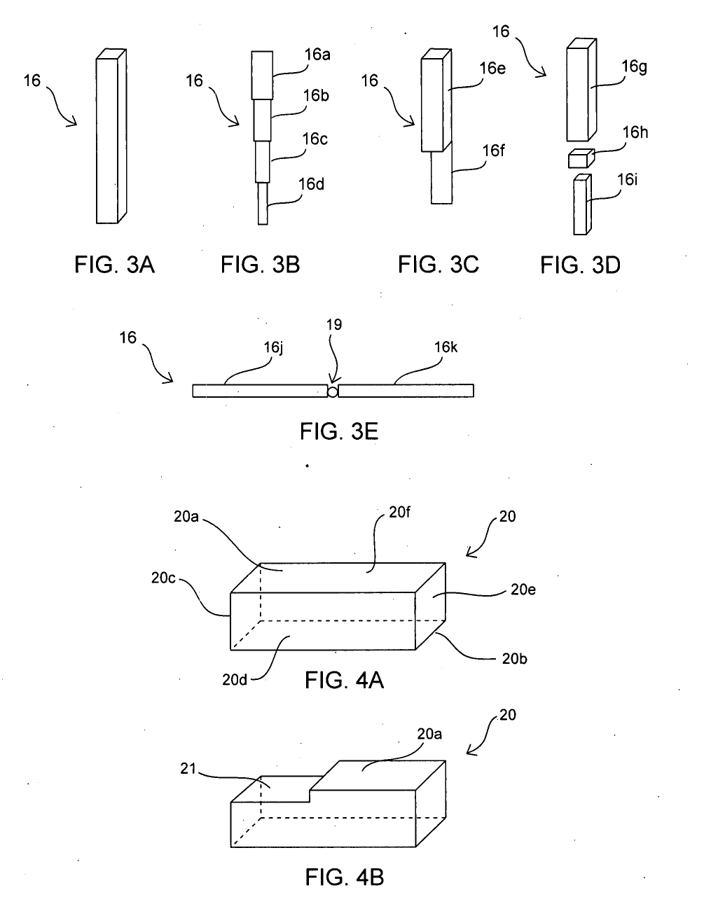

With reference to FIG. 3, a representative embodiment of a stabilizing leg component of the subject invention is provided. In FIG. 3A, a representative leg component (16) is set forth. As illustrated in FIG. 3B, the leg component (16) is a telescoping leg component, wherein the leg component (16) includes a plurality of segments (16a, 16b, 16c, and 16d), which components are configured for being inserted and/or received one within the other in the fashion of a collapsible telescope. As illustrated in FIG. 3C, a representative leg component (16) includes two portions of differing dimensions (16e and 16f, wherein portion (16e) is extended and includes a greater height dimension than portion (16f), and wherein portion (16f) includes a smaller height dimension than 16(e) and is therefore relatively flattened as compared to portion (16f). Accordingly, portion (16f) is configured for being contacted with an object, such as the tire of a car, without causing a substantial disruption in the stability of the support stand and is yet capable of still supporting the stand. As illustrated in FIG. 3D, the leg component (16) includes two portions (16g and 16i), which may be of differing dimensions, and which are joinable by attachment to an adapter element (16h). As illustrated in FIG. 3E a leg component (16) includes two leg portions (16j and 16k), which portions are movably associated with one another through an intervening joint element (19).

With reference to FIG. 4, a representative embodiment of a rack engagement element supporting member (e.g., a striker plate) of the subject invention is provided. In FIG. 4A, a representative striker plate is set forth wherein the striker plate (20) includes a top surface (20a), a bottom surface (20b), and four walls (20c, 20d, 20e, and 20f). As illustrated in FIG. 4B, the striker plate (20) includes a notch section (21), on top surface 20a, which is configured for receiving a rack engagement element.

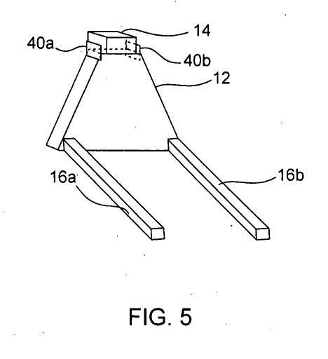

With reference to FIG. 5, a representative embodiment of a support stand for a utility rack of the subject invention is provided. As illustrated the support stand (10) includes a generally triangular shaped, rigid base member (12). The base member (12) includes raised portions (40a and 40b) extending above a top surface (12a) of the base. For instance, in certain embodiments, the raised portions may be a bracket element which is mounted to the top surface of the base member (12) and aligned longitudinally along a plane center of the base member (12). As illustrated, the raised portions attach to a rectangular shaped rack engagement element (14). Numerous leg components (e.g., support members) (16a and 16b) are attached to the base member (12). Accordingly, in connection with the base member (12) the leg supports (16a and 16b) extend outward from the base member (12) and support the forward, rear, and lateral stability of the rack stand support, so as to support a rack system whether the rack is fully loaded to its capacity or not.

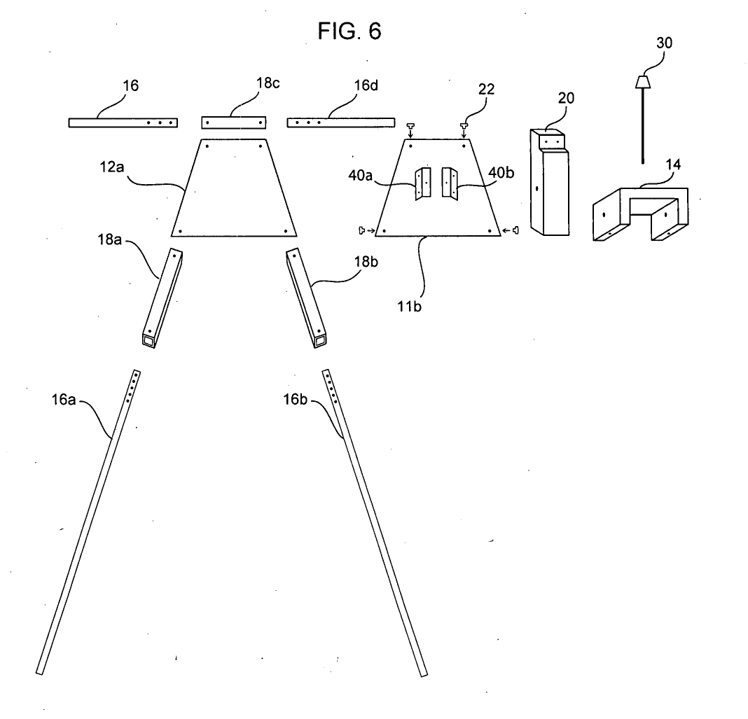

With reference to FIG. 6, a representative embodiment of various components of a support stand for a utility rack of the subject invention is provided. The support stand for a utility rack (10) includes a bottom base member (12) and a top base member (11). Additionally, the support stand includes three stabilizing leg receiving components (18a, 18b, and 18c) and four stabilizing leg components (16a, 16b, 16c and 16d). Further, the stand (10) includes a rack engagement element supporting member (20), a rack engagement element (14), and a locking pin (30). As can be seen with reference to FIG. 6, the components set forth therein all include openings through which various fasteners, such as elements (22) may be inserted so as to allow the assembly to easily be joined together or broken down into its component parts. Wheels and/or raiser pads (not shown) can also be included.

As illustrated, the utility rack support stand (10) of the subject invention is easy to assembly and is therefore collapsible. Accordingly, in one aspect of the invention, a method of assembling a utility rack stand support is provided, wherein the method includes the steps of providing one or more of the stand components described herein, e.g., a top and/or bottom base member(s), stabilizing leg receiving component(s), stabilizing leg component(s), a rack engagement element supporting member, a rack engagement element, and/or a locking pin; and joining the various elements of the stand together, for instance, by inserting fasteners through the included openings in the components.

For instance, in certain embodiments, a bottom base stand is provided, a leg component may then be attached directly to the base member or be indirectly associated with the base member through a leg receiving component, in which instance the leg receiving portion is either attached to the base first or the leg is inserted into the base member and the two components are attached to the base member via inserting the appropriate sized fasteners through the aligned holes of the included components. If a top base member is to be included it may be associated with the leg and/or leg receiving receptacles before the fasteners are inserted through the aligned openings so as to join the various members together. Where a bracket is included in the base member, the bracket is associated with the base member (via the insertion of fasteners through the bracket and into the base plate, and a striker plate may then be inserted in to the space between the brackets, and firmly associated with the brackets by inserting one or more fasteners through one or more openings in the walls of the brackets and into the striker plate. A rack engagement element may be associated with the striker plate, either before or after the striker plate is inserted through the brackets of the base member, by inserting one or more appropriately sized fasteners, e.g., screws, through openings in the engagement element that are aligned with openings in the striker plate, e.g., one or more openings in a notched portion of the striker plate.

Once the stand support is assembled, a trailer hitch engagement portion may then be inserted into the rack engagement element so that included locking pin openings in the engagement element and the hitch engagement portion are aligned and a locking pin may be inserted there through so as to lock the utility rack to the support stand. A cotter pin may then be inserted through the locking pin to further secure the locking pin in relationship to the engagement element and hitch engagement portion. Accordingly, in one aspect of the invention, a method for using a utility rack stand support is provided, wherein the method includes one or more of providing the components to be included in the fully assembled stand and assembling the stand, or other wise providing an assembled stand, and inserting an engagement portion of a utility rack into the engagement element of the stand and inserting a locking pin there though to lock the two in place. Once the rack is firmly associated with the stand the rack may be loaded, e.g., to its full capacity with equipment so as to store the equipment.

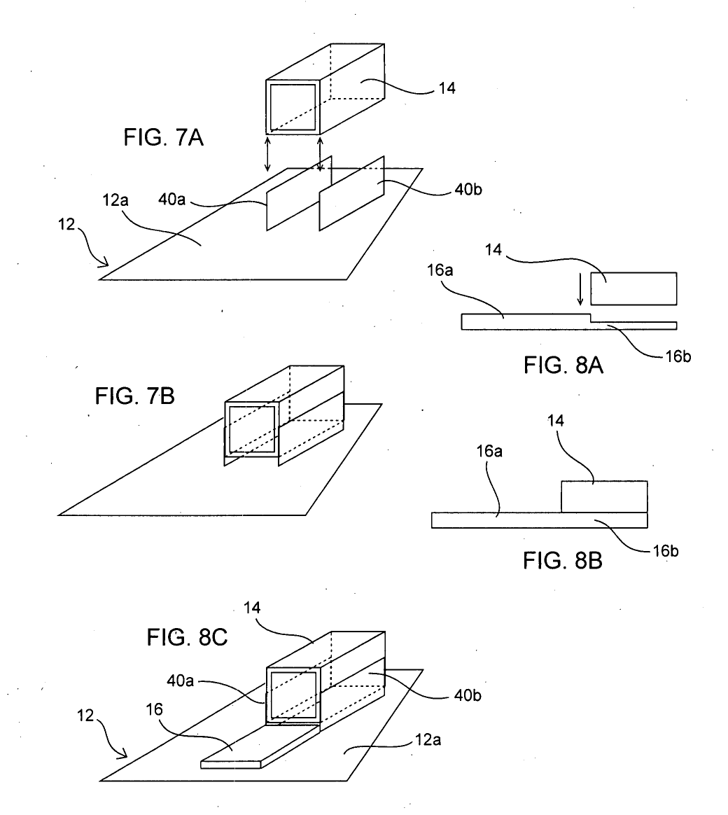

With reference to FIG. 7, a representative embodiment of a base plate that is associated with a plurality of bracket members on a surface thereof in accordance with the subject invention is provided. In FIG. 7A, a base plate (12) is provided and brackets (40a and 40b) have been associated therewith on a surface 12(a) of the base plate (12). As illustrated, a rack engagement element (14) may be inserted between the two brackets (40a and 40b) so as to be associated with both the brackets (40a,b) and the base plate (12), as shown in FIG. 7B.

With reference to FIG. 8, a representative embodiment of a rack engagement element supporting member in association with a rack engagement element is provided. In FIG. 8A a rack engagement element supporting member, e.g., a striker plate (16), with a non-notched portion (16a) and a notched portion (16b) is provided. As shown, a rack engagement element (14) may be associated with the notched portion (16b) of the striker plate, as shown in FIG. 8B. FIG. 8C illustrates a base member (12) that has been associated on a surface thereof (12a) with a rack engagement element supporting member (16). Brackets (40a, 40b) have been included, wherein the space between the brackets is configured for accommodating both the supporting member (16) and the engagement element (14).

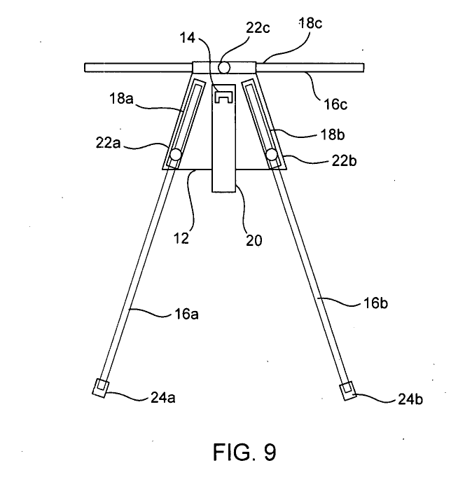

A fully assembled stand support is set forth in FIG. 9. The support stand for a utility rack (10) includes a bottom base member (12) and three stabilizing leg receiving components (18a, 18b, and 18c) along with three stabilizing leg components (16a, 16b, and 16c, e.g., two side legs and one back leg). Further, the stand (10) includes a rack engagement element supporting member (20), a rack engagement element (14), and fasteners (22a, 22b, and 22c). As can be seen with reference to FIG. 9, the supporting member (20) has a length whereby the supporting member (20) extends beyond the length of the base (12), however, the supporting member (20) may have any suitable length, such as a length that allows the supporting member (20) to be flush with an end of the base (16) or a length whereby the supporting member (20) is less than the length of the base (12) and does not go beyond the bounds of the base (12). Pads (24a, 24b, 24c and 24d) have also be provided, it is noted that locking wheels can also be included, e.g., in place of the pads.

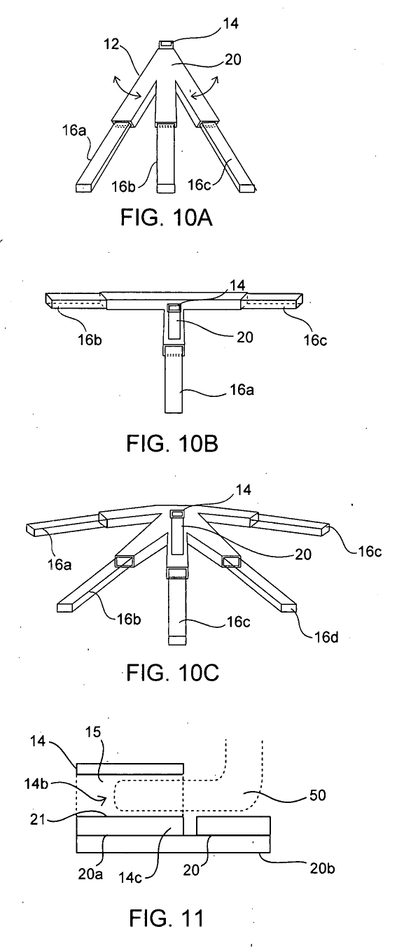

With reference to FIG. 10, a representative embodiment of a utility rack support stand is provided. As illustrated in FIG. 10A, the stand includes a tubular base member (12) in the shape of a pyramid, which base member includes leg receptacle portions integral therein, leg components (16a, 16b, and 16c) that associate with an L-shaped adapter (not shown), which L-shaped adapter then fits into the leg receptacle portions of the base member (12). A rack engagement element (14) is also mounted onto a top surface of the base member (12). In this embodiment, the raised configuration of the base member (12) serves the purpose of raising the engagement element (14) vertically. As illustrated in FIG. 10B, the stand includes a tubular base member (12) in the shape of a T, which base member includes leg receptacle portions integral therein, leg components (16a, 16b, and 16c) fit into the leg receptacle portions of the base member (12). A striker plate (20) is also included and attached to a top surface of the base (12), and a rack engagement element (14) is also mounted onto a top surface of the striker plate (20). As illustrated in FIG. 10C, the stand includes a tubular base member (12) in the shape of a half-star, which base member includes leg receptacle portions integral therein, leg components (16a, 16b, 16c, 16d, and 16e) fit into the leg receptacle portions of the base member (12). A striker plate (20) is also included and attached to a top surface of the base (12), and a rack engagement element (14) is also mounted onto a top surface of the striker plate (20).

With reference to FIG. 11, a representative embodiment of a rack engagement element and a rack engagement element supporting member of the subject invention is provided. In FIG. 11, the rack engagement element (14) includes four walls (14a, 14b, 14c, and 14d—not shown) which bound a lumen (15) into which a trailer-hitch engagement portion (50) is inserted. A rack engagement element supporting member (20) is also set forth wherein the supporting member (20) includes a proximal portion (20a), with a cut out (e.g., notch) portion (21) configured for receiving a rack engagement element (14), and a distal portion (20b), which does not include a cutout portion. As illustrated in FIG. 11, the supporting member (20) includes a rack engagement element (14), on top surface (20a) of notch portion (21).

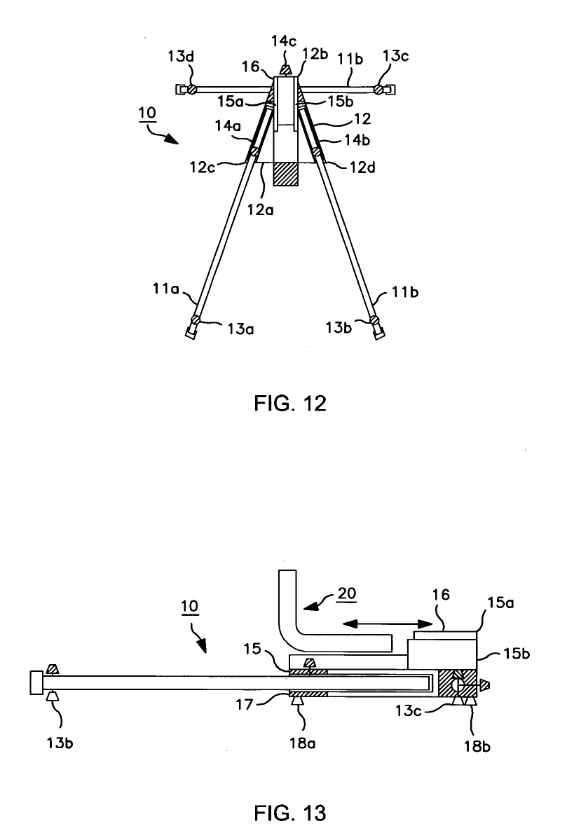

With reference to FIGS. 12 and 13, a particular embodiment of the present invention is shown in two perspectives. FIG. 12 shows a top view perspective therein, and FIG. 13 shows a profile perspective therein.

In FIG. 12, the present invention provides a rack support stand (10), which includes leg components or support members made of rigid material such as steel, or aluminum, items 11(a), 11(b), and 11(c). All three support members are of equal diameter and insert into, or through, the base (I2) therein. The base (12) is made out of rigid material such as steel, or aluminum, or hardened plastic, or a combination of such. The far ends of the three support members rest on pads that can be adjusted to level the stand 13 (a), 13 (b), 13(c), and 13(d). The base (12) is configured to be wide at the front 12(a), and narrow at the rear 12(b). The two Front support members 11(a) and 11(b) are of equal length and are shown therein to be inserted into the front of the base 12 on the inside edge of each side of the base 12 (c) and 12 (d). They are secured by the base 12 for the purpose of supporting weight, and to provide stability. Due to the configuration of the base 12, the two front support members 11(a) and 11(b) are elongated and spatially separated from each other becoming wider apart as they extend away from the base.

The front support members 11(a) and 11(b) combined with the base 12 support forward, rear, and lateral stability. The remaining rear support member 11(c) is elongated and slides through the back of the base until the ends of the rear support member 11(c) are equally spread apart. The rear support member is shown therein with its center aligned with the center axis of the base. Each support member 11(a), 11(b), and 11(c) are shown therein to be locked into place by the base I2 by locking knobs I4(a), 14(b), and I4 (c). The rear support member 11(c) is combined with the base 12, and the front support members 11(a) and 11(b) work in unison to support a capacity loaded rack system.

A support plate 15 made of rigid material such as steel, or aluminum is shown therein attached to the top surface of the base 12. Brackets I5 (a), and I5 (b) made of rigid material such as steel, or aluminum are attached to the support plate I5 in such a way as to allow a stand receiver also made of rigid material such as steel, or aluminum 16 to slide in between the brackets 15(a) and 15(b) for attachment to the brackets. The brackets 15(a) and 15(b) may have various attachment points for the stand receiver 16. This is for the purpose of adjusting the location of the stand receiver 16 to adapt to various sizes of rack systems. The stand receiver 16 has inside dimensions equal to the dimensions of a standard 2 inch tow hitch receiver, and is long enough to support the weight and desired position of a capacity loaded rack system.

FIG. 13 shows a stand 10 of the present invention including the items listed in FIG. 12, and shows the bottom portion of a rack system 20 that is specifically designed to be inserted into a trailer hitch receiver for the purpose of transporting various items such as bicycles, skis snow boards, wheel chair, or cargo container, or the like, but is shown as it would be inserted into the stand receiver 16 of the stand 10. A bottom support plate I7 is shown therein attached to the base 12. The bottom support plate I7 is of equal size and dimensions to the top support plate 15 also shown. The top and bottom plates 15 and I7 work in unison to provide structure and strength to the stand base 12. The bottom support plate 17 rests on four fixed pads, I8(a) and I8(b) as shown, and I8(c) and 18(d) not shown. These fixed pads work in unison with four adjustable pads mounted near the ends of each of the support members 13(b) and 13(c) shown and I3(a) and I3(d) not shown. All pads work in unison to level the stand 10 when resting on a flat surface. The bottom end of a rack system 20 is shown therein as it would be while being inserted into the receiver of the stand 10.

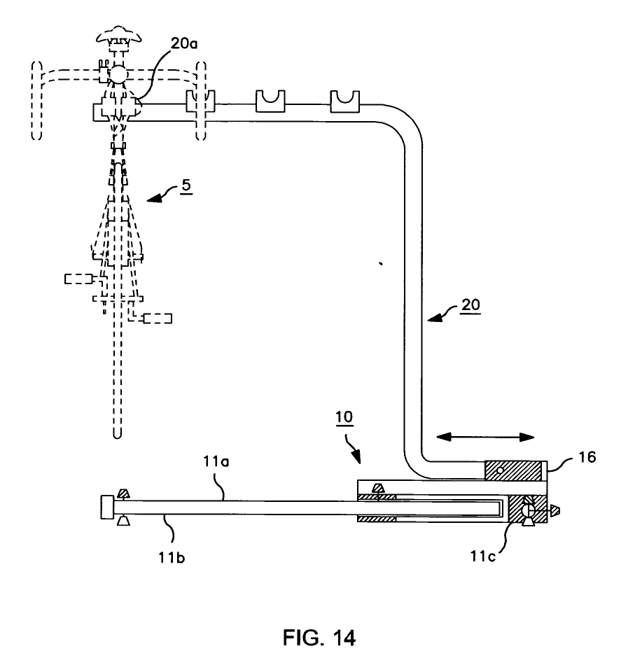

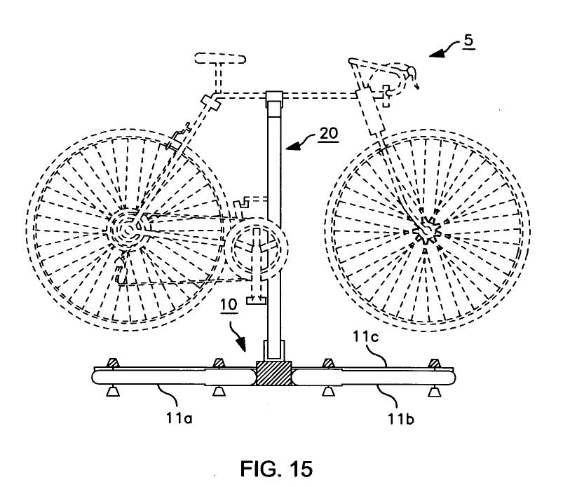

In FIG. 14, a profile perspective is shown therein of the stand 10 of the present invention supporting a rack system 20 that is specifically designed to be inserted into a trailer hitch receiver mounted on to a vehicle for the purpose of transporting equipment, such as bicycles, skis, snow boards, or the like. The rack system 20 is shown to be inserted into the stand receiver 16 of the present invention 10, and supported by the present invention 10 in an upright position as they would be resting on a flat surface such as a garage floor. The front view of a bicycle 5 is shown therein secured by one of the mounts 20(a) attached to the rack system 20. This profile perspective of both the stand 10, and rack system 20 supporting a bicycle 5 at the furthest end of the rack system is shown to convey the ability of the stand I0 to support the distributed weight of bicycles loaded onto the rack system 20. All support members 11(a), 11(b), and 11(c) of the stand 10 may be extended or contracted to support capacity loads of various rack system configurations. FIG. 15 is a front perspective shown of the stand 10 of the present invention with a rack system 20 and bicycle 5 as they would be with the stand 10 resting on a flat surface such as a garage floor. This front perspective also shows the support members 11(a), 11(b), and 11(c) working in unison to support side to side, and forward to rear stability of a capacity loaded rack system 20.

Accordingly, in view of the above, in one particular embodiment, a stand for a hitch receiver rack system is provided, wherein the stand includes a generally triangular shaped, rigid, base member having raised portions projecting above the top surface of the base member. The raised portions may be mounted to the base member and may be located longitudinally along the plane center axis of the base member. The raised portions may be attached to a rectangular shaped receiver. The inside dimensions of the receiver may be, for instance, 2 inches wide by 2 inches tall and about six inches deep. The stand may additionally include numerous support members which are attached to and secured by the base member. These support members may extend outward from the base member. The support members combined with the base member may support forward, rear, and lateral stability sufficient to support a rack system loaded to its capacity. For instance, the bottom of a rack system may be pushed into the stand receiver to be supported in an upright position by the stand.

While the invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the invention. All such modifications are intended to be within the scope of the claims appended hereto.

What is claimed is:

1. A support stand for a utility rack; the support stand comprising:
a. a base member;
b. a stabilizing leg component associated with said base member and configured for stabilizing said support stand; and a
c. a utility rack engagement element adapted for engaging a portion of a utility rack.

2. The support stand according to claim 1, wherein said base component comprises a shape selected from the group consisting of a circle, triangle, square, rectangle, trapezoid, diamond, pentagon, and hexagon.

3. The support stand according to claim 1, wherein the support stand further comprises a plurality of leg components.

4. The support stand according to claim 1, wherein the support stand further comprises a stabilizing leg receiving component.

5. The support stand according to claim 1, wherein said utility rack engagement element further comprises a cavity, wherein said cavity is adapted for receiving said portion of the utility rack.

6. The support stand according to claim 5, wherein the utility rack engagement element comprises a plurality of walls.

7. The support stand according to claim 6, wherein said walls of the utility rack engagement element comprise brackets.

8. The support stand according to claim 7, wherein said brackets are adapted for engaging a portion of the utility rack.

9. The support stand according to claim 8, wherein said brackets are moveably associated with said base member.

10. The support stand according to claim 1, further comprising a utility rack engagement element bearing member associated with said engagement element and configured for bearing the weight of the portion of the utility rack.

11. The support stand according to claim 10, wherein said utility rack engagement element bearing member is interposed between said base component and said engagement member.

12. The support stand according to claim 11, wherein said utility rack engagement element is moveably associated with the utility rack engagement element bearing member.

13. The support stand according to claim 5, further comprising a securing element adapted for being inserted into said utility rack engagement element and thereby securing said portion of the utility rack within said cavity of said utility rack engagement element.

14. The support stand according to claim 1, further comprising a second base component wherein said second base component is configured for associating with a top surface of said leg components.

15. A support stand for a utility rack; the support stand comprising:
a. a triangular shaped base member, comprising a raised portion adapted for receiving a utility rack engagement element; and
b. a utility rack engagement element adapted for engaging a portion of a utility rack.

16. The support stand according to claim 15, further comprising a stabilizing leg component associated with said base member and configured for stabilizing said support stand.

17. The support stand according to claim 16, further comprising a plurality of leg components.

18. The support stand according to claim 17, wherein the support stand further comprises a plurality of stabilizing leg receiving components.

19. The support stand according to claim 16, further comprising a utility rack engagement element bearing member associated with said engagement element and configured for bearing the weight of the portion of the utility rack.

20. The support stand according to claim 1, wherein said utility rack is configured for retaining a member selected from the group consisting of a bicycle, a ski, a snowboard, wheel chair, and cargo container.
